(19) United States
(12) Patent Application Publication
(10) Pub. No.: US 2010/0131598 A1
(43) Pub. Date: May 27, 2010

(54) USER ALERT IF A PERSON WILL BECOME UNAVAILABLE

(75) Inventor: Gabriel Ruelas-Arana, Jalisco (MX)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/275,314

(22) Filed: Nov. 21, 2008

(51) Int. Cl. G06F 15/16

(52) U.S. Cl. 709/206

(57) ABSTRACT

A method of implementing user alert if a person will become unavailable includes sending, using a calendar program, information to a messaging program about an event scheduled in the calendar program by a user, wherein, during the event, the user will be unavailable to communicate with other persons; receiving, using the messaging program, the information about the event from the calendar program; creating, using the messaging program, a list of recipients who need to be informed of when the user will become unavailable to communicate with other persons; and creating and sending, using the messaging program, an alert message about the event to the recipients.

### BACKGROUND

This invention relates generally to user alerts, and particularly to a user alert if a person will become unavailable.

Employee teams often depend on guidance from team leaders to accomplish their work objectives. For example, a software development team may rely on an architect leader or project manager for answers to their questions in order to complete a software project. However, such leaders are often also busy with other matters, such as attending meetings or otherwise becoming unavailable for periods of time during work hours. Therefore, work on a project may be delayed or interrupted if a team needs the guidance of its team leader when unavailable. Furthermore, the longer the team leader is unavailable, for example, during a long meeting, the more impact there may be on the team's productivity. However, a team's advance knowledge that its team leader will become unavailable provides the ability to avoid or minimize such impacts.

### BRIEF SUMMARY

A method of implementing user alert if a person will become unavailable includes, in exemplary embodiment, sending, using a calendar program, information to a messaging program about an event scheduled in the calendar program by a user, wherein, during the event, the user will be unavailable to communicate with other persons; receiving, using the messaging program, the information about the event from the calendar program; creating, using the messaging program, a list of recipients who need to be informed of when the user will become unavailable to communicate with other persons; and creating and sending, using the messaging program, an alert message about the event to the recipients.

A corresponding system embodiment and computer program product embodiment are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured to provide a user alert if a person will become unavailable.

FIG. 2 is a block diagram illustrating an exemplary subsystem of the exemplary computing device of FIG. 1 operable to provide a user alert if a person will become unavailable.

FIG. 3 is a flow diagram illustrating an example of a method to provide a user alert if a person will become unavailable, which is executable, for example, on the exemplary computing device of FIG. 1.

The detailed description explains the preferred embodiments of the invention, together with advantages and features, by way of example with reference to the drawings.

### DETAILED DESCRIPTION

According to exemplary embodiments of the invention described herein, a user alert if a person will become unavailable is provided. In accordance with such exemplary embodiments, an alert provides advance knowledge (e.g., to a team member) that a person (e.g., a team leader) will become unavailable, thereby providing the team member (or other person who needs to be informed of such unavailability) with an opportunity to contact the person before the person becomes unavailable.

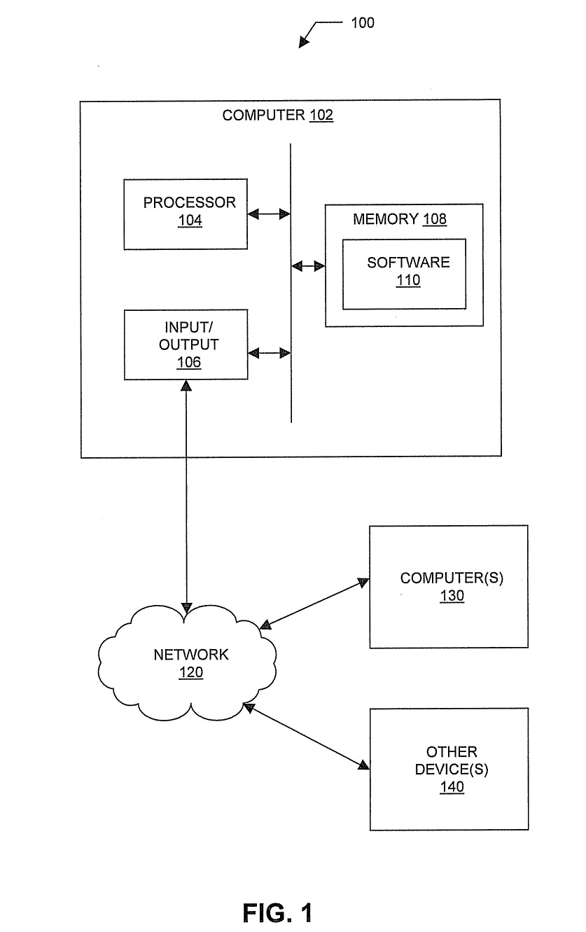

Turning now to the drawings in greater detail, wherein like reference numerals indicate like elements, FIG. 1 illustrates an example of a computer system 100 including an exemplary computing device (“computer”) 102 configured to provide a user alert if a person will become unavailable. In addition to computer 102, exemplary computer system 100 includes network 120, computing device(s) (“computer(s)”) 130, and other device(s) 140. Network 120 connects computer 102, computer(s) 130, and other device(s) 140 and may include one or more wide area networks (WANs) and/or local area networks (LANs) such as the Internet, intranet(s), and/or wireless communications network(s). Computer(s) 130 may include one or more other computers, e.g., that are similar to computer 102 and which, e.g., may operate as a server device, client device, etc. within computer system 100. Other device(s) 140 may include one or more other computing devices that provide data storage and/or other computing functions. Computer 102, computer(s) 130, and other device(s) 140 are in communication via network 120, e.g., to communicate data between them. In some embodiments, computer 102 and/or one or more of computer(s) 130 may be a portable, mobile, etc. computing device (e.g., a PDA, smartphone, laptop, etc.)

Exemplary computer 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computer 102, such as a display, keyboard, modem, network adapter, ports, etc. (not depicted). Memory 108 includes software 110 configured to provide a user alert if a person will become unavailable, which is executable, e.g., by computer 102 via processor 104. Memory 108 may include other software, data, etc. (not depicted), such as a calendar program and a messaging program (as further discussed below).

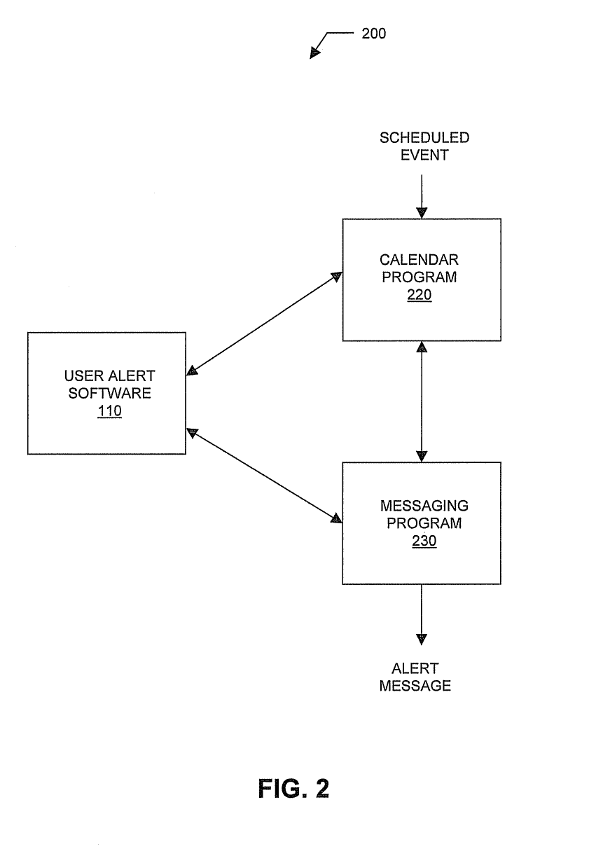

FIG. 2 illustrates an exemplary subsystem 200 of the exemplary computer 102 of FIG. 1 operable to provide a user alert if a person will become unavailable. Exemplary subsystem 200 includes software (or “user alert software”) 110, which, as described above, is configured to provide a user alert if a person will become unavailable and is executable, e.g., by computer 102 via processor 104. Subsystem 200 also includes a calendar program (calendar management program, scheduling program, schedule management program, etc.) 220 and messaging program 230, which are also executable, e.g., by computer 102 via processor 104, and may also be stored in memory 108. Calendar program 220 is operable to schedule events (e.g., entered by a user of computer 102). Messaging program 230 is in operative communication with the calendar program 220 and is operable to create, send, and receive messages. User alert software 110 is in operative communication with the calendar program 220 and the messaging program 230. In some embodiments, the messaging program 230 may be an instant messaging, text messaging, or email program. Furthermore, user alert software 110 may be separate from or integrated with the calendar program 220 and/or the messaging program 230 (e.g., as a software plug-in, applet, modification, etc.).

Subsystem 200 is operable to configure (enable, facilitate, etc.) the calendar program 220 via the user alert software 110 to send information to the messaging program 230 about a calendar event (“event”) scheduled in the calendar program 220 by a user, where, during the event, the user will be unavailable to communicate with other persons. The event may include, e.g., attending a meeting or other matter that causes the uses to become unavailable for periods of time during work hours. In some embodiments, subsystem 200 is operable to configure the calendar program 220 via the user alert software 110 to send the information to the messaging program 230 a configurable (e.g., by a user) amount of time before the start of the event. For example, calendar program 220 may be configured to send the information 15 minutes, 30 minutes, etc. before the start of the event to provide recipients of the alert message with sufficient advanced notice in case they need to contact the user before the user becomes unavailable.

Subsystem 200 is also operable to configure the messaging program 230 via the user alert software 110 to receive the information about the event from the calendar program 220. Furthermore, subsystem 200 is operable to configure the messaging program 230 via the user alert software 110 to create a list of recipients who need to be informed of when the user will become unavailable to communicate with other persons. In some embodiments, subsystem 200 is operable to configure the messaging program 230 to create a list of recipients that includes members of an employee team or group, persons specified by the user, and/or persons requesting to receive the alert message by sending a request message to the messaging program 230.

Subsystem 200 is also operable to configure the messaging program 230 via the user alert software 110 to create and send an alert message about the event to the recipients. In some embodiments, the alert message includes a statement (e.g., an announcement) that the event will occur, when the event will occur, the duration of the event, and an invitation to contact the user before the event if needed. In some embodiments, subsystem 200 is further operable to configure the messaging program 230 via the user alert software 110 to receive alert messages from other persons based on a setting by the user.

In some embodiments, subsystem 200 is further operable to send the information to the messaging program 230 via the calendar program 220 a configurable amount of time before the start of the event, receive the information from the calendar program 220 via the messaging program 230, format the information to create the alert message via the messaging program 230, and send the alert message to the recipients via the messaging program 230. In such embodiments, subsystem 200 may be further operable to receive a communication from one of the recipients via the messaging program 230 before the start of the event in response to the alert message. Configuring of the calendar program 220 and messaging program 230 via user alert software 110 as described above may include configuring settings, protocols, etc. of the programs 220, 230.

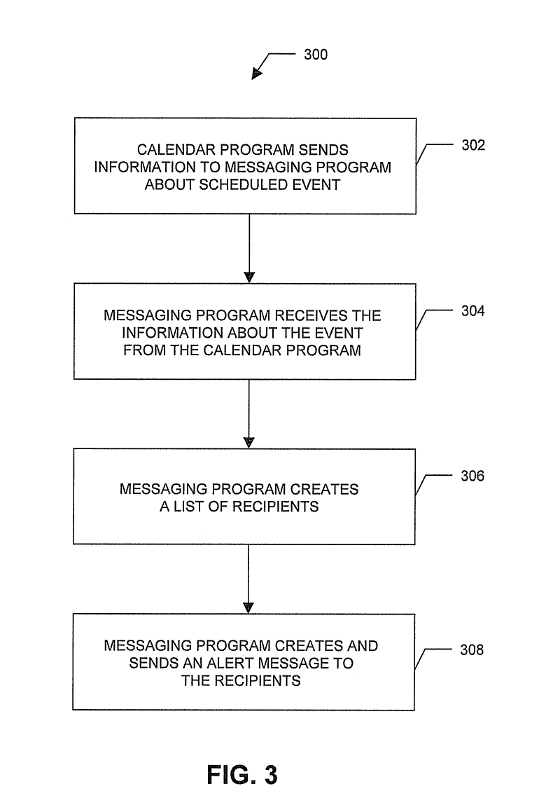

FIG. 3 illustrates an example of a method 300 to provide a user alert if a person will become unavailable, which is executable, for example, on the exemplary computer 102 of FIG. 1 (e.g., as a computer program product). Exemplary method 300 may also describe an exemplary operation, e.g., by exemplary computer 102 and subsystem 200, to provide a user alert if a person will become unavailable. In block 302, a calendar program sends information to a messaging program about an event scheduled in the calendar program by a user, where, during the event, the user will be unavailable to communicate with other persons. In some embodiments, the messaging program is an instant messaging, text messaging, or email program. In some embodiments, the sending of information by the calendar program to the messaging program in block 302 includes the calendar program sending the information to the messaging program a selectable amount of time before the start of the event.

In block 304, the messaging program receives the information about the event from the calendar program. In block 306, the messaging program creates a list of recipients who need to be informed of when the user will become unavailable to communicate with other persons. In some embodiments, creating a list of recipients in block 306 includes creating a list of recipients that includes members of an employee team or group, persons specified by the user, and/or persons requesting to receive the alert message by sending a request message to the messaging program. In such embodiments, the user may, e.g., be a team leader, project manager, or other person who is relied upon for guidance to complete a work project.

In block 308, the messaging program creates and sends an alert message about the event to the recipients. In some embodiments, the alert message includes a statement that the event will occur, when the event will occur, the duration of the event, and an invitation to contact the user before the event if needed.

In some embodiments, method 300 further includes the messaging program receiving alert messages from other persons based on a setting by the user. In some embodiments, method 300 further includes sending the information to the messaging program via the calendar program a selectable amount of time before the start of the event, receiving the information from the calendar program via the messaging program, formatting the information to create the alert message via the messaging program, and sending the alert message to the recipients via the messaging program. In such embodiments, method 300 further includes receiving a communication from one of the recipients via the messaging program before the start of the event in response to the alert message.

The following is an exemplary scenario in accordance with the above described exemplary method 300 to provide a user alert if a person will become unavailable utilizing, e.g., a computer system configured in accordance with the above described exemplary computer system 100 and subsystem 200. In the exemplary scenario, a software architect leader has entered a scheduled meeting event occurring from 1 PM to 3 PM into a calendar program configured in accordance with method 300, during which time the architect leader will be unavailable to be contacted by software team members who rely on the architect leader for project management. The architect leader has also previously configured the calendar program (e.g., via the user alert software) to send such event information to a messaging program (also configured according to method 300) 30 minutes before the start of the event so that the messaging program will create and send a text alert message to team member recipients designated by the architect leader.

As a result, at 12:30 PM on the day of the event, the designated team member recipients receive a text alert message from the messaging program that informs the recipients of the architect leader's pending unavailability for the meeting, thereby providing the recipients with the opportunity to contact the architect leader up to 30 minutes before the meeting rather than having to wait to contact the architect leader two hours later after the meeting ends at 3 PM. This allows the team members to avoid impacts to their productivity that would result from work delays or interruptions due to the unavailability of the architect leader to be contacted for guidance, assistance, etc.

Exemplary computer system 100, computer 102, and subsystem 200 are illustrated and described with respect to various components, modules, etc. for exemplary purposes. It should be understood that other variations, combinations, or integrations of such elements that provide the same features, functions, etc. are included within the scope of embodiments of the invention.

The flowchart and/or block diagram(s) in the Figure(s) described herein illustrate the architecture, functionality, and/or operation of possible implementations of systems, methods, and/or computer program products according to various embodiments of the present invention. In this regard, each block in a flowchart or block diagram may represent a module, segment, or portion of code, which comprises one or more executable instructions for implementing the specified logical function(s). It should also be noted that, in some alternative implementations, the functions noted in a flowchart or block diagram may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in a flowchart or block diagram can be implemented by special purpose hardware-based systems that perform the specified functions or acts, or combinations of special purpose hardware and computer instructions.

The terminology used herein is for the purpose of describing exemplary embodiments and is not intended to be limiting of the present invention. As used herein, the singular forms “a”, “an”, and “the” are intended to include the plural forms as well, unless the context clearly indicates otherwise. It will be further understood that the terms “comprises”, “comprising”, “includes”, or “including” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The exemplary embodiment(s) were chosen and described in order to explain the principles of the present invention and the practical application, and to enable others of ordinary skill in the art to understand the present invention for various embodiments with various modifications as are suited to the particular use contemplated.

As will be appreciated by one skilled in the art, the present invention may be embodied as a system, method, and/or computer program product. Accordingly, the present invention may take the form of an entirely hardware embodiment, an entirely software embodiment (including firmware, resident software, micro-code, etc.), and/or or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart and/or block diagram blocks.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method, comprising:
sending, using a calendar program, information to a messaging program about an event scheduled in the calendar program by a user, wherein, during the event, the user will be unavailable to communicate with other persons;
receiving, using the messaging program, the information about the event from the calendar program;
creating, using the messaging program, a list of recipients who need to be informed of when the user will become unavailable to communicate with other persons; and
creating and sending, using the messaging program, an alert message about the event to the recipients.

2. The method of claim 1, wherein sending information to the messaging program includes sending the information to the messaging program a selectable amount of time before the start of the event.

3. The method of claim 1, wherein creating a list of recipients comprises creating a list of recipients comprising members of an employee team or group, persons specified by the user, or persons requesting to receive the alert message by sending a request message to the messaging program.

4. The method of claim 1, wherein the alert message includes a statement that the event will occur, when the event will occur, the duration of the event, and an invitation to contact the user before the event if needed.

5. The method of claim 1, further comprising receiving, using the messaging program, alert messages from other persons based on a setting by the user.

6. The method of claim 1, further comprising:
sending the information to the messaging program via the calendar program a configurable amount of time before the start of the event;
receiving the information from the calendar program via the messaging program;
formatting the information to create the alert message via the messaging program; and
sending the alert message to the recipients via the messaging program.

7. The method of claim 6, further comprising receiving a communication from one of the recipients via the messaging program before the start of the event in response to the alert message.

8. The method of claim 1, wherein the messaging program is an instant messaging, text messaging, or email program.

9. A system, comprising:
a calendar program operable to schedule events;
a messaging program in operative communication with the calendar program and operable to create, send, and receive messages; and
a user alert software in operative communication with the calendar program and the messaging program, wherein the system is operable to:
utilize the calendar program via the user alert software to send information to the messaging program about an event scheduled in the calendar program by a user, wherein, during the event, the user will be unavailable to communicate with other persons;
utilize the messaging program via the user alert software to receive the information about the event from the calendar program;
utilize the messaging program via the user alert software to create a list of recipients who need to be informed of when the user will become unavailable to communicate with other persons; and
utilize the messaging program via the user alert software to create and send an alert message about the event to the recipients.

10. The system of claim 9, wherein the system is operable to utilize the calendar program via the user alert software to send information to the messaging program by configuring the calendar program to send the information to the messaging program a configurable amount of time before the start of the event.

11. The system of claim 9, wherein the system is operable to utilize the messaging program to create a list of recipients by configuring the messaging program to create a list of recipients comprising members of an employee team or group, persons specified by the user, or persons requesting to receive the alert message by sending a request message to the messaging program.

12. The system of claim 9, wherein the alert message includes a statement that the event will occur, when the event will occur, the duration of the event, and an invitation to contact the user before the event if needed.

13. The system of claim 9, wherein the system is further operable to utilize the messaging program via the user alert software to receive alert messages from other persons based on a setting by the user.

14. The system of claim 9, wherein the system is further operable to:
send the information to the messaging program via the calendar program a configurable amount of time before the start of the event;
receive the information from the calendar program via the messaging program;
format the information to create the alert message via the messaging program; and
send the alert message to the recipients via the messaging program.

15. The system of claim 14, wherein the system is further operable to receive a communication from one of the recipients via the messaging program before the start of the event in response to the alert message.

16. The system of claim 9, wherein the messaging program is an instant messaging, text messaging, or email program.

17. A computer program product, comprising a computer usable medium having a computer readable program, wherein the computer readable program, when executed on a computer, causes the computer to:
utilize a calendar program to send information to a messaging program about an event scheduled in the calendar program by a user, wherein, during the event, the user will be unavailable to communicate with other persons, and wherein the calendar program and the messaging program are also executed on the computer;
utilize the messaging program to receive the information about the event from the calendar program;
utilize the messaging program to create a list of recipients who need to be informed of when the user will become unavailable to communicate with other persons; and
utilize the messaging program to create and send an alert message about the event to the recipients.

18. The computer program product of claim 17, wherein the computer readable program causes the computer to utilize the calendar program to send information to the messaging program by utilizing the calendar program to send the information to the messaging program a selectable amount of time before the start of the event.

19. The computer program product of claim 17, wherein the computer readable program causes the computer to utilize the messaging program to create a list of recipients by utilizing the messaging program to create a list of recipients comprising members of an employee team or group, persons specified by the user, or persons requesting to receive the alert message by sending a request message to the messaging program.

20. The computer program product of claim 17, wherein the alert message includes a statement that the event will occur, when the event will occur, the duration of the event, and an invitation to contact the user before the event if needed.

21. The computer program product of claim 17, wherein the computer readable program further causes the computer to utilize the messaging program to receive alert messages from other persons based on a setting by the user.

22. The computer program product of claim 17, wherein the computer readable program further causes the computer to:
send the information to the messaging program via the calendar program a configurable amount of time before the start of the event;
receive the information from the calendar program via the messaging program;
format the information to create the alert message via the messaging program; and
send the alert message to the recipients via the messaging program.

23. The computer program product of claim 22, wherein the computer readable program further causes the computer to receive a communication from one of the recipients via the messaging program before the start of the event in response to the alert message.

24. The computer program product of claim 17, wherein the messaging program is an instant messaging, text messaging, or email program.
